(19) United States
(12) Patent Application Publication
(10) Pub. No.: US 2020/0412740 A1
(43) Pub. Date: Dec. 31, 2020

(54) METHODS, DEVICES AND SYSTEMS FOR THE DETECTION OF OBFUSCATED CODE IN APPLICATION SOFTWARE FILES

(71) Applicant: Vade Secure, Inc., San Francisco, CA (US)

(72) Inventors: Sebastien GOUTAL, San Francisco, CA (US); Maxime Marc MEYER, Montreal (CA)

(21) Appl. No.: 16/455,404

(22) Filed: Jun. 27, 2019

(51) Int. Cl. H04L 29/06; H04L 12/58; G06F 21/54; G06Q 10/10

(52) U.S. Cl. CPC H04L 63/123; H04L 63/145; G06Q 10/107; H04L 51/12; G06F 21/54; H04L 51/08

(57) ABSTRACT

A computer-implemented method of detecting obfuscated code in an electronic message's attachment may comprise receiving, over a computer network, an electronic message comprising an attachment; determining the file type of the attachment; extracting one or more scripts from the attachment, computing a distance measure between selected one or more features of the extracted one or more scripts and corresponding one or more selected features of scripts of a model corpus of non-obfuscated script files and comparing the computed distance measure with a threshold. When the computed distance measure is at least as great as the threshold, it may be determined that the extracted one or more scripts comprise obfuscated code and a defensive action with respect to at least the attachment may be taken. When the computed distance measure is less than the threshold, it may be determined that the extracted one or more scripts does not comprise obfuscated code.

### BACKGROUND

Application software suites such as Microsoft® Office® and Adobe® Acrobat® allow the end user to edit complex documents that contain text, tables, charts, pictures, videos, sounds, hyperlinks, interactive objects, etc. Some of these rich content features rely on the support of scripting languages by application software suites, such as Visual Basic® for Application (abbreviated VBA) for Microsoft® Office® suite and JavaScript® (abbreviated JS) for Adobe® Acrobat® suite:
VBA for Microsoft® Office® may be used for task automation (Formatting, editing, correction, etc.), interactions with the end user and interactions between Microsoft® Office® applications.
JS for Adobe® Acrobat® may be used for automation of forms handling, communication with web and database and interaction with the end user.

Cybercriminals have leveraged the support of scripting languages in these application software files and have written malicious code to perform malicious actions such as installing malware (Ransomware, spyware, trojan, etc.) on the end user's device, re-directing the end user to a phishing website, etc. As security vendors have started to develop technologies to detect malicious VBA and JS scripts, cybercriminals have increased the sophistication of their cyberattacks using different techniques, such as source code obfuscation.

Source code obfuscation is the deliberate act of creating source code that is difficult for humans to understand. Source code obfuscation is widely used in the software industry, mainly to protect source code and to deter reverse engineering for security and intellectual property reasons. Source code obfuscation, however, is very rarely used in benign VBA and JS scripts embedded in Microsoft® Office® and Adobe® Acrobat® files, as those scripts are usually simple and many do not have any intellectual property value.

The detection of obfuscated code, therefore, can be a useful tool in detecting potentially malicious code in malware.

### BRIEF DESCRIPTION OF THE DRAWINGS

FIG. 1 shows examples of JavaScript® (JS) obfuscation techniques used by cybercriminals to obfuscate malicious code.

FIG. 2 shows examples of code obfuscation in Visual Basic® for Application (VBA).

FIG. 3 shows the default VBA script created by Microsoft® Excel® in the first sheet of a Microsoft® Excel® spreadsheet, when the language in the Operating System is English.

FIG. 4 shows the default VBA script created by Microsoft® Excel® in the first sheet of a Microsoft® Excel® spreadsheet, when the language in the Operating System is French.

FIG. 5 shows an example of a benign script where the JS script checks the version of XFA (XML Forms Architecture) in a PDF document.

FIG. 6 shows an example of a signature named ExcelSheetDefaultScript that can match the scripts presented in FIGS. 3 and 4.

FIG. 7 shows several discrete probability distribution models M_{L}={M_{L,1}, . . . , M_{L,q}} that may be generated from the parsing and analysis of ModelCorpus_{L}, according to one embodiment.

FIG. 8 is a flowchart of a computer-implemented method for detecting obfuscated code, according to one embodiment.

FIG. 9 is a flowchart of an exemplary use case of an email received by a MTA (Message Transfer Agent) via SMTP (Simple Mail Transfer Protocol) and the detection of obfuscated code, according to one embodiment.

FIG. 10 is a diagram illustrating further aspects of detecting obfuscated code in an email received by a MTA via SMTP, according to one embodiment

FIG. 11 is a flowchart of a computer implemented method of detecting obfuscated code, according to one embodiment.

FIG. 12 is a block diagram of a computing device with which aspects of an embodiment may be practiced.

### DETAILED DESCRIPTION

In the context of malicious code, obfuscation has one main purpose: to bypass security vendor's filtering technologies. More precisely:
Obfuscation largely relies on randomization techniques, making each instance of malicious code very likely to be unique. As a consequence, filtering technologies that rely on fingerprints (Cryptographic hash, local sensitive hash, etc.) are inefficient in blocking such cyberthreats.
Obfuscation usually hides suspect features (Function name, object name, URL, etc.) that may help to detect the underlying malicious behavior. Thus, filtering technologies relying on extraction of features coupled with a decision algorithm (Decision tree, binary classifier, etc.) are also inefficient in blocking such cyberthreats.

The following lists a few common JS obfuscation techniques used by cybercriminals to obfuscate malicious code:
Randomization of whitespaces,
Randomization of variable names,
Randomization of function names,
Randomization of comments,
Data obfuscation (string splitting, keyword substitution, etc.),
Encoding obfuscation (hexadecimal encoding, octal encoding, etc.), and
Logic structure obfuscation.

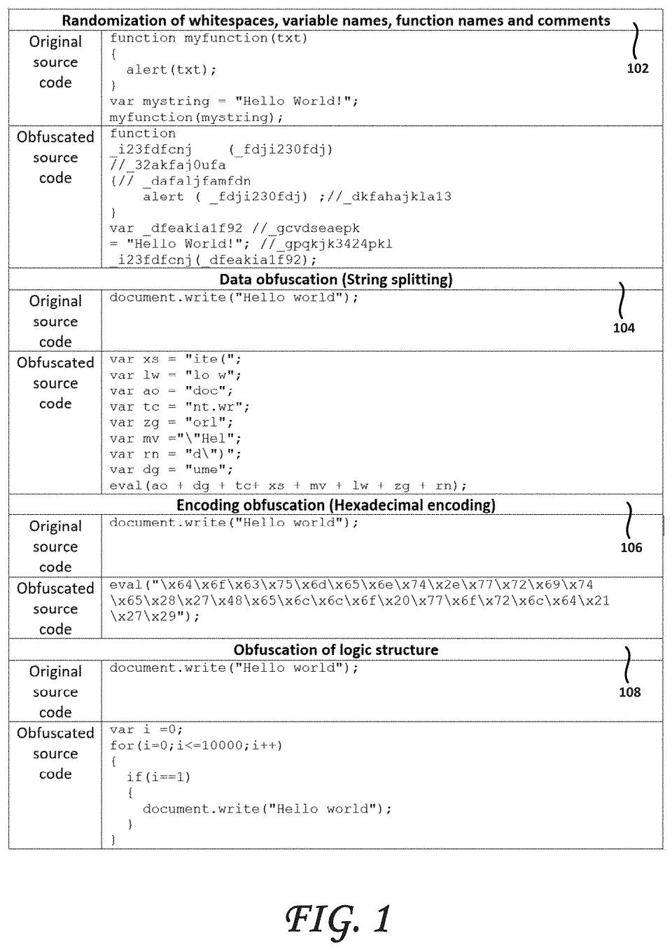

FIG. 1 is a table illustrating a number of such obfuscating techniques for JS, namely the randomization of whitespace, variable names, function names and comments 102, data obfuscation (in this case, String splitting) 104, encoding obfuscation (in this case, Hexadecimal encoding) 106 and, as shown at 108, obfuscation of logic structure. As shown at 102, the variable names, function names and comments of the original source code have been obfuscated by replacing them with difficult (for humans) to read text substitutions. The functionality is the same, but the code is no longer clearly and intuitively understandable. At reference 104, the string document.write(“Hello World”); has been split into eight separate string fragments and assigned to eight different variables. An eval function then executes the concatenated string fragments to display the “Hello world” iconic phrase from Kernighan & Richie's 1978 seminal “The C Programming Language” tome. As shown at 106, instead of splitting the string up, the same expression may be obfuscated by replacing the constituent characters with their respective hexadecimal equivalents. Lastly, as shown at 108, the simple JS function document.write is embedded in a useless loop, thereby making otherwise simple code complex and opaque.

The aforementioned list of obfuscation techniques is not exhaustive, and these techniques may be combined with one another and/or other techniques to achieve even higher levels of obfuscation.

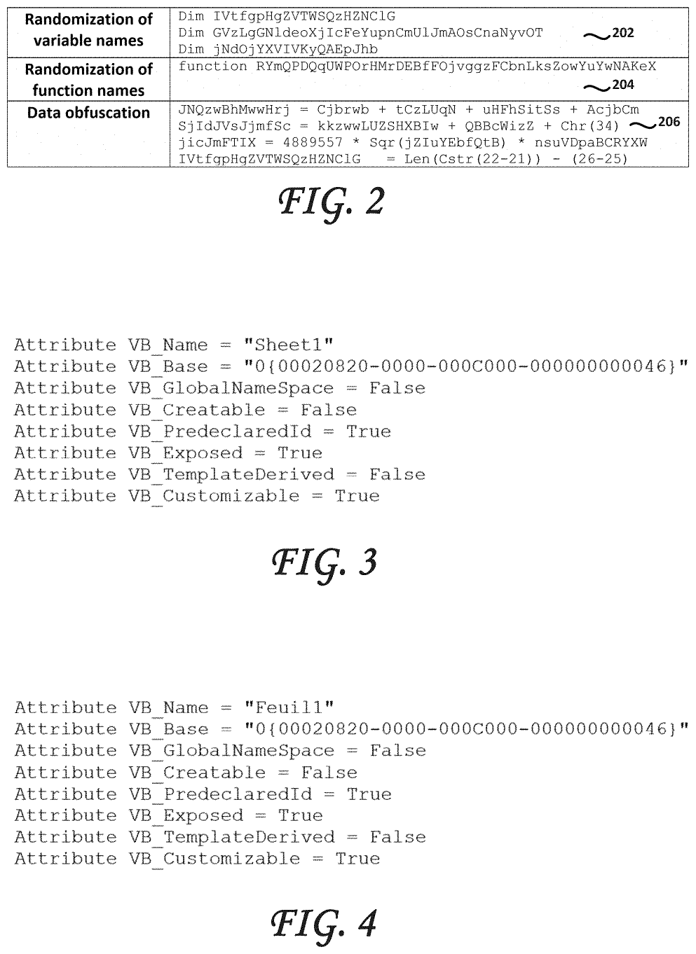

Similar obfuscation techniques exist in VBA. FIG. 2 shows examples of code obfuscation in VBA. Examples of randomization of variable names, of function names and data obfuscation are shown at reference numbers 202, 204 and 206, respectively.

According to one embodiment, a function called EvaluateFile may be defined, in which:
The input is a file f
The output is one of the following:
   NoCode: file f doesn't contain any code;
   BenignCodeOnly: file f contains only code that is known to be benign;
   NotEnoughData: file f contains code but there is not enough data to determine whether the code is obfuscated or not;
   CodeNotObfuscated: file f contains code and this code is not obfuscated; or
   CodeObfuscated: file f contains code and this code is obfuscated, and thus potentially malicious.

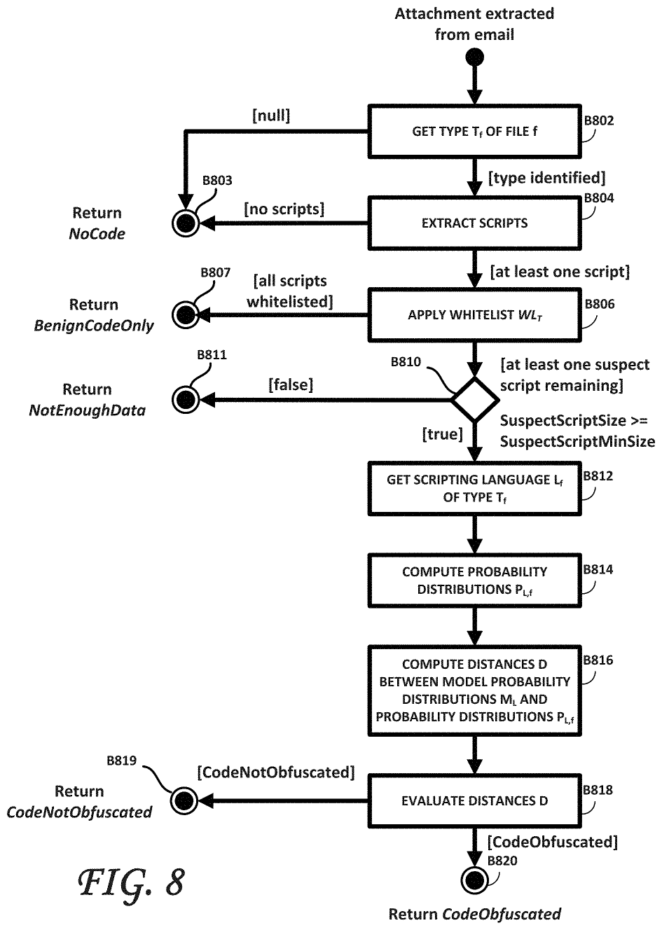

The EvaluateFile function and its use is shown relative to FIG. 8, discussed infra.

### Determination of File Type

The following data is defined:

| | |
|---|---|
| T | Type of application software suite that may contain one |
| | or several scripts. T is an element of |
| | AppSoftwareSuites = |
| | [MicrosoftOffice, Adobe Acrobat}. Other types of |
| | software application suites may be defined. |
| T_{f} | Type of file f. |
| getType | Return type T_{f} of file f if T_{f} is an element of |
| | AppSoftwareSuites. If the type is not an application |
| | software suite that may contain one or several scripts, the |
| | function returns null. File type is typically identified by |
| | extracting the magic number (a file signature, such as a |
| | sequence of bytes that is used to identify the type of the |
| | file) and then parsing the file with the appropriate parser |
| | to ensure that the file is valid. |
| | Formally we have: T_{f} = getType(f) |

In the highlighted steps below, computer-implemented methods for determining whether code is obfuscated according to embodiments are detailed with reference to FIG. 8. At the outset, after the attachment is extracted from the electronic message (e.g., email) a determination of the file type may be performed, as shown in FIG. 8 at block B802.

Step 1: A getType function may be called to identify the type T_{f} of the file f. If T_{f} is not null then T_{f} identifies the type of application software suite and the EvaluateFile function proceeds to the next step. Otherwise, if T_{f} equals null, then EvaluateFile function exits and returns NoCode, as shown at B803 in FIG. 8. It is to be noted that application software suites covered by this disclosure include, but are not limited to, Microsoft® Office® and Adobe® Acrobat®.

Extraction of Scripts

The following data is defined:

| | |
|---|---|
| s_{f, i} | A script contained in file f. |
| S_{f} = {s_{f, 1}, . . . , s_{f, m}} | List of m ≥ 0 scripts s_{f, i} extracted from file f. |
| extractScripts | Extract scripts from file f using a parser specific |
| | to T_{f}. Formally we have: S_{f} = extractScripts(f, T_{f}) |

Step 2: As shown at B804 in FIG. 8, the extractScripts function is called to extract scripts from the file f. If at least one script is extracted, then the EvaluateFile function proceeds to the next step. Otherwise, if no script is extracted, then EvaluateFile function exits and returns NoCode, as shown at B803. At this stage, scripts S_{f}={s_{f,1}, . . . , s_{f,m}} have been extracted from file f. Some of the extracted scripts may be benign, while others may be malicious.

Whitelisting of Benign Scripts

Files created with application software suites such as Microsoft® Office® and Adobe® Acrobat® may contain benign scripts. For example, FIG. 3 and FIG. 4 show the default VBA script created by Microsoft® Excel® in the first sheet of a Microsoft® Excel® spreadsheet, when the language in the Operating System is configured in English (FIG. 3) or French (FIG. 4). Notice that the values of VB_Name attributes are different, while the values of other attributes are identical. If the Operating System configured language is English, the attribute value contains “Sheet” which is an English word. If the Operating System configured language is French, the attribute value contains “Feuil” which is the truncation of “Feuille”, the French word for “Sheet”.

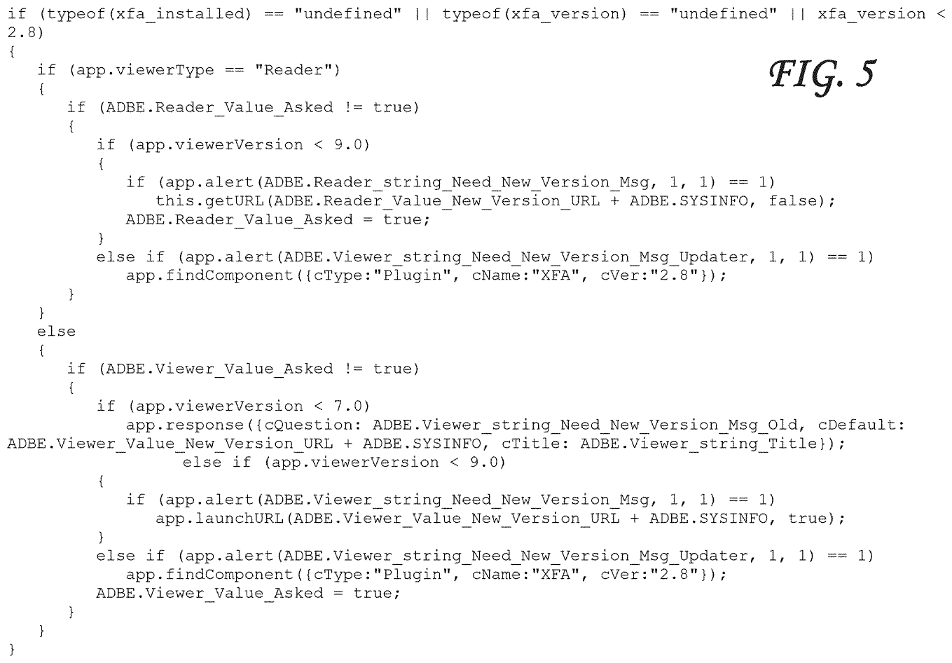

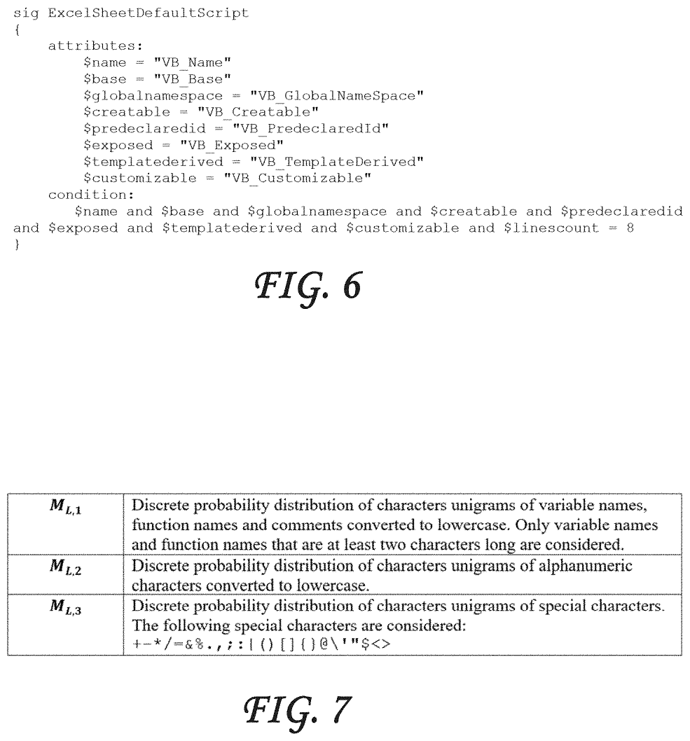

Another example of a benign script is shown in FIG. 5 where the JS script checks the version of XFA (XML Forms Architecture) in a PDF document. There are different variants of this JS script. As these scripts are very common and are benign, one embodiment comprises implementing a whitelist WL_{T}={wl_{T1}, . . . , wl_{T,n}} for each type T, where wl_{T,i} is a whitelist element that identifies a particular typology of benign script. The whitelist may be implemented in different ways. One way to implement it is to use a list of signatures using a format that is sufficiently flexible to capture variants of the same script, such as those presented in FIGS. 3 and 4. FIG. 6 shows an example of a signature named ExcelSheetDefaultScript that can identify the scripts presented in FIGS. 3 and 4. The semantic of this signature can be interpreted as follows: if all the attributes defined in the attributes section are found in the script, and if the script lines count is equal to 8, then the script is whitelisted; that is, the analyzed script is not considered as suspect and thus is removed from the list of scripts.

One embodiment defines an applyWhitelist function. The following data is defined:

| | |
|---|---|
| s′_{f, i} | A suspect script contained in file f. |
| S′_{f} = {s′_{f, 1}, . . . , s′_{f, p}} | List of p ≥ 0 suspect scripts s′_{f, i} |
| | extracted from file f. Note that S′_{f} is |
| | a subset of S_{f}. Formally we have: |
| | S′_{f} ⊆ S_{f} |
| applyWhitelist | Apply whitelist WL_{T} on scripts |
| | S_{f} = {s_{f,1}, . . . , s_{f, m}} |
| | and return remaining suspect scripts. |
| | A script s_{f, j} is whitelisted if and only if there |
| | is at least one element wl_{T, i} of WL_{T} = |
| | {wl_{T, 1}, . . . , wl_{T, n}} that matches s_{f, j}. |
| | Formally we have: |
| | S′_{f} = applyWhitelist(S_{f}, WL_{T}) |

Step 3: As shown at B806 in FIG. 8, the applyWhitelist function may be called to identify whitelisted scripts and return remaining suspect scripts. If at least one suspect script is remaining, then the EvaluateFunction function proceeds to the next step. Otherwise, if no suspect script is remaining, then EvaluateFile function exits and returns BenignCodeOnly, as shown at block B807.

Size Condition on Suspect Scripts

At this point of execution of the present computer-implemented method according to an embodiment, a non-zero list of suspect scripts S′_{f}={s′_{f,1}, . . . , s′_{f,p}} has been extracted from file f. The algorithm should be provided with sufficient data to determine, with the requisite degree of accuracy, whether the code is obfuscated or not. Indeed, if there is insufficient data, a sufficiently accurate statistical representation of the suspect scripts may not be obtained.

The following data may be defined:

| | |
|---|---|
| SuspectScriptsSize | Size in bytes of S′_{f} = {s′_{f, 1}, . . . , s′_{f, p}} |
| SuspectScriptsMinSize | Threshold in bytes |

Step 4: As suggested at B810 in FIG. 8, the SuspectScriptsSize may be computed and compared to the SuspectScriptsMinSize. If SuspectScriptsSize≥SuspectScriptsMinSize, then the EvaluateFunction function proceeds to the next step. Otherwise, EvaluateFile function exits and returns NotEnoughData, as shown at B811 in FIG. 8.

Determination of Scripting Language

The following data may be defined:

| | |
|---|---|
| L | Scripting language. L is an element of |
| | ScriptingLanguages = {VBA, JS}. |
| | Other scripting languages may be defined. |
| L_{f} | Scripting language potentially used in file f. |
| getScriptingLanguage | Return scripting language L_{f} associated |
| | to type T_{f}. It is assumed that a unique |
| | scripting language L_{f} is associated to type T_{f}. |
| | Formally we have: |
| | L_{f} = getScriptingLanguage(T_{f}) |
| | For example: |
| | VBA = getScriptingLanguage(MicrosoftOffice) |
| | JS = getScriptingLanguage(AdobeAcrobat) |

Step 5: If the SuspectScriptsSize is sufficiently large, the scripting language L_{f} may be identified, as suggested at B812 in FIG. 8, by evaluating the variable L_{f} using the function getScriptingLanguage: L_{f}=getScriptingLanguage(T_{f}). It is to be noted that although VBA and JS are used as examples herein, the scope of the embodiments shown and described herein is not limited to those scripting languages.

Statistical Modeling of Scripting Languages

Code obfuscation techniques, such as those presented in FIG. 1 and FIG. 2, usually produce code with statistical features that differ from statistical features of non-obfuscated code. In the fields of computational linguistics and probability, an n-gram is a contiguous sequence of n items from a given sample of text or speech. The items can be phonemes, syllables, letters, words or base pairs according to the application. The n-grams typically are collected from a text or speech corpus. For example, using Latin numerical prefixes, a n-gram of size 1 is referred to as a “unigram”; size 2 is a “bigram” (or, less commonly, a “digram”); size 3 is a “trigram”. If we consider character unigrams, the statistical distribution of variable names, function names and comments of a non-obfuscated source code written in English is quite similar to the statistical distribution thereof in the English language, as most of the words used to name variables, to name functions, and to comment the code are English words. However, if we consider obfuscated code such as the ones presented in FIGS. 1 and 2, embodiments comprise the discovery and realization that the statistical distribution of variable names, function names and comments is very dissimilar to the statistical distribution thereof in the English language.

The following data is defined:

| | |
|---|---|
| ModelCorpus_{L} | A non-obfuscated code model corpus |
| | for scripting language L. |
| M_{L} = {M_{L, 1}, . . . , M_{L, q}} | List of q > 0 discrete probability |
| | distribution models. |
| P_{L, f} ⁼ {P_{L, f, 1}, . . . , P_{L, f, q}} | List of q > 0 discrete probability |
| | distribution computed from the parsing |
| | and analysis of S′_{f} . |

For each scripting language L, a non-obfuscated code model corpus ModelCorpus_{L} may be built. For example:
ModelCorpus_{VBA} is a non-obfuscated code model corpus constructed by extracting VBA scripts from a corpus of benign Microsoft® Office® files.
ModelCorpus_{JS} is a non-obfuscated code model corpus constructed by extracting JS scripts from a corpus of benign PDF files and from a corpus of the most commonly used JS libraries (both minified and un-minified versions of the libraries). As is known, the goal of minification is to minimize JS script file size so that the loading of a webpage is faster. It is achieved by compressing the code: remove whitespaces, shorten functions and variables names, etc.

One or several discrete probability distribution models M_{L}={M_{L,1}, . . . , M_{L,q}} may be generated from the parsing and analysis of ModelCorpus_{L}, examples of which are provided in FIG. 7. Notice that the M_{L,1} model presented in FIG. 7 only considers features of the extracted script(s) such as variable names and function names that are at least two characters long: this condition is related to the fact that minified source code typically contains one-character long function names and variable names that most likely follows a uniform distribution. It may be, therefore, advisable to exclude those function names and variable names from the discrete probability models. The features of the extracted scripts considered by the M_{L,2} model presented in FIG. 7 are alphanumeric characters, and the features of the extracted scripts considered by the M_{L,3} model presented in FIG. 7 are special characters, such as those shown in the discrete probability distribution shown in Table 1 below.

Table 1 shows M_{JS,3} i.e., the discrete probability distribution of character unigrams of special characters of ModelCorpus_{JS}.

TABLE 1
Discrete probability distribution of characters
unigrams of special characters of JS model corpus

| Character | Frequency |
|---|---|
| + | 0.012506 |
| - | 0.010293 |
| * | 0.028653 |
| / | 0.066624 |
| = | 0.068254 |
| & | 0.021478 |
| % | 0.000309 |
| . | 0.098704 |
| , | 0.092112 |
| ; | 0.059175 |
| : | 0.054344 |
| \| | 0.012685 |
| ( | 0.089209 |
| ) | 0.089256 |
| [ | 0.014267 |
| ] | 0.014279 |
| { | 0.049132 |
| } | 0.049013 |
| @ | 0.007056 |
| \ | 0.006616 |
| ′ | 0.029593 |
| ″ | 0.101405 |
| $ | 0.011614 |
| < | 0.006485 |
| > | 0.006937 |

Similarly, one or several discrete probability distributions P_{L,f}={P_{L,f,1}, . . . , P_{L,f,q}} may be generated from the parsing and analysis of the list of suspect scripts S′_{f}={s′_{f,1}, . . . , s′_{f,p}}.

Distances Computation Between Models and Suspect Scripts

Step 6: As shown at B816 in FIG. 8, the distance between discrete probability distributions D={D₁, . . . , D_{q}} may then be computed. Indeed, according to one embodiment, the distance between two probability distributions may be computed. Examples of distance metrics that may be used are the Jensen-Shannon distance and the Wasserstein distance, although other distance metrics may also be used.

Considering now the previously-presented obfuscation techniques and the discrete probability distribution models presented relative to FIG. 7 collectively yields the following observations, according to embodiments:
If S′_{f} contains many randomizations of variable names, function names and/or comments, then the distance between M_{L,1} and P_{L,f,1} will be high, as the statistical distribution of characters used in variable names, functions names and/or comments will be very different. As an illustration, if we consider the example of randomization of variable names, function names and comments 102 presented in FIG. 1, the ‘−’ character appears 8 times and the ‘2’ and ‘3’ characters appear 5 times, whereas the original script does not contain any of those characters in variables names, function names and comments.
If S′_{f} contains a large amount of encoding obfuscation, then the distance between M_{L,2} and P_{L,f,2} will be high, as the statistical distribution of alphanumeric characters will be very different. As an illustration, if we consider the hexadecimal encoding obfuscation example 106 presented in FIG. 2, the ‘x’ character appears 30 times and the ‘6’ character appears 15 times, whereas the original script does not contain any ‘ x’ or ‘ 6’ characters.
If S′_{f} contains many string splitting obfuscations, then the distance between M_{L,3} and P_{L,f,3} will be high, as the statistical distribution of features of the extracted script(s) such as special characters will be very different. As an illustration, if we consider the string splitting example presented at 104 in FIG. 1, the ‘+’ character appears 7 times and the ‘=’ character appears 8 times, whereas the original script does not contain either the ‘+’ or the ‘=’ character.

Table 2 shows the discrete probability function of characters unigrams of special characters of the obfuscated script presented at 104.

TABLE 2
Discrete probability distribution of characters unigrams
of special characters of JS script with string splitting

| Character | Frequency |
|---|---|
| + | 0.142857 |
| - | 0.000000 |
| * | 0.000000 |
| / | 0.000000 |
| = | 0.163265 |
| & | 0.000000 |
| % | 0.000000 |
| . | 0.020408 |
| , | 0.000000 |
| ; | 0.183673 |
| : | 0.000000 |
| \| | 0.000000 |
| ( | 0.040816 |
| ) | 0.040816 |
| [ | 0.000000 |
| ] | 0.000000 |
| { | 0.000000 |
| } | 0.000000 |
| @ | 0.000000 |
| \ | 0.040816 |
| ′ | 0.000000 |
| ″ | 0.367347 |
| $ | 0.000000 |
| < | 0.000000 |
| > | 0.000000 |

The computation of distances between M_{L}={M_{L,1}, . . . , M_{L,q}} and P_{L,f}={P_{L,f,1}, . . . , P_{L,f,q}} is helpful in characterizing and detecting many obfuscation techniques, as long as the models are carefully defined and constructed. For example, if the Jensen-Shannon distance JSD with base 2 logarithm between the probability distributions of Table 1 and Table 2 is computed, then JSD=0.650 where JSD is rounded up to three decimal places.

The following data are defined:

| | |
|---|---|
| Dᵢ | A distance between two discrete probability |
| | distributions. |
| D = {D₁, . . . , D_{q}} | List of q > 0 distances between discrete |
| | probability distributions. |
| Dist | A function that computes a distance between two |
| | discrete probability distributions. |
| | Formally we have: |
| | ∀i ∈ [l, q] Dᵢ = Dist(M_{L, i}, P_{L, f, i}) |
| | And by extension: |
| | D = Dist(M_{L}, P_{L, f}) |

Step 7: Compute distances between M_{L} and P_{L,f}: D=Dist(M_{L},P_{L,f}), as shown at B816 in FIG. 8.

Evaluation of Distances Between Probability Distributions

Finally, according to one embodiment, the distance D is evaluated with the EvaluateDist function defined below:

| | |
|---|---|
| EvaluateDistThreshold | Threshold used by EvaluateDist. |
| EvaluateDist | A function that evaluates D = {D₁, . . . , D_{q}} |
| | and returns a binary decision, either |
| | CodeObfuscated or CodeNotObfuscated. |
| | Different algorithms may be applied |
| | to make the CodeObfuscated or |
| | CodeNotObfuscated decision,such as: |
| | EvaluateDist returns CodeObfuscated when |
| | the average value of D = {D₁, . . . , D_{q}} |
| | is greater or equal than threshold |
| | EvaluateDistThreshold. |
| | Otherwise EvaluateDist returns |
| | CodeNotObfuscated. |
| | EvaluateDist returns CodeObfuscated when |
| | the maximal value of D = {D₁, . . . , D_{q}} is |
| | greater or equal than a threshold |
| | EvaluateDistThreshold. |
| | Otherwise EvaluateDist returns |
| | CodeNotObfuscated. |

In order to set the threshold to a value yielding satisfying detection results, several methods may be applied. In one embodiment, the threshold may be set by considering the bounds of the distance algorithm used. For example, if we consider the Jensen-Shannon distance with base 2 logarithm, then EvaluateDistThreshold could be set to 0.5 as the Jensen-Shannon distance with base 2 logarithm between two probability distributions P and Q has the following property: 0≤JSD(P∥Q)≤1.

In one embodiment, the threshold may be set to a dynamically-determined value by applying the EvaluateFile function on a test corpus TestCorpus_{L} constructed beforehand for this purpose. TestCorpus_{L} may include t application software files F_{NonObf}={f_{NonObf,1}, . . . , f_{NonObf,t}} with non-obfuscated code and t application software files F_{Obf}={f_{Obf,1}, . . . , f_{Obf,t}} with obfuscated code, where code is written in scripting language L. Then, the following algorithm may be applied:
TestCorpus_{L} corpus is shuffled randomly to randomly order the files present in TestCorpus_{L} corpus;
The value of the threshold is then initialized as described previously; e.g., initialized to 0.5, for example, if Jensen-Shannon distance with base 2 logarithm is considered;
EvaluateFile function is then applied on each file f of the corpus, and the threshold is updated as follow:
   If EvaluateFile(f_{NonObf,i}) returns CodeNotObfuscated then do nothing;
   If EvaluateFile(f_{Obf,i}) returns CodeObfuscated then do nothing;
   If EvaluateFile(f_{NonObf,i}) returns CodeObfuscated, then increase the value of the threshold by a small amount, the amount depending on the distance metric and the distance from the current value to the upper bound of the distance metric;
   If EvaluateFile(f_{Obf,i}) returns CodeNotObfuscated then decrease the value of the threshold by a small amount, the amount depending on the distance metric and the distance from the current value to the lower bound of the distance metric.

Step 8: Finally, as shown at B818 in FIG. 8, sufficient information is now available to call the EvaluateDist(D) function and determine whether the code is obfuscated or is not obfuscated.
If CodeObfuscated is returned, then EvaluateFile function exits and returns CodeObfuscated
If CodeNotObfuscated is returned, then EvaluateFile function exits and returns CodeNotObfuscated

Use Case Example: Email Received by a MTA

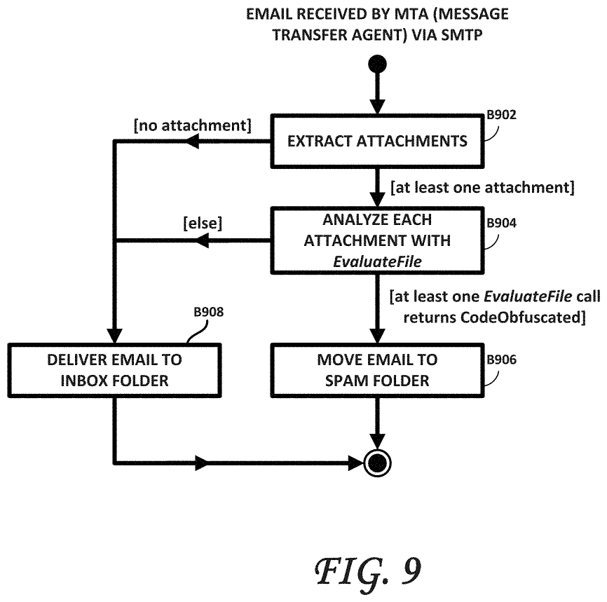

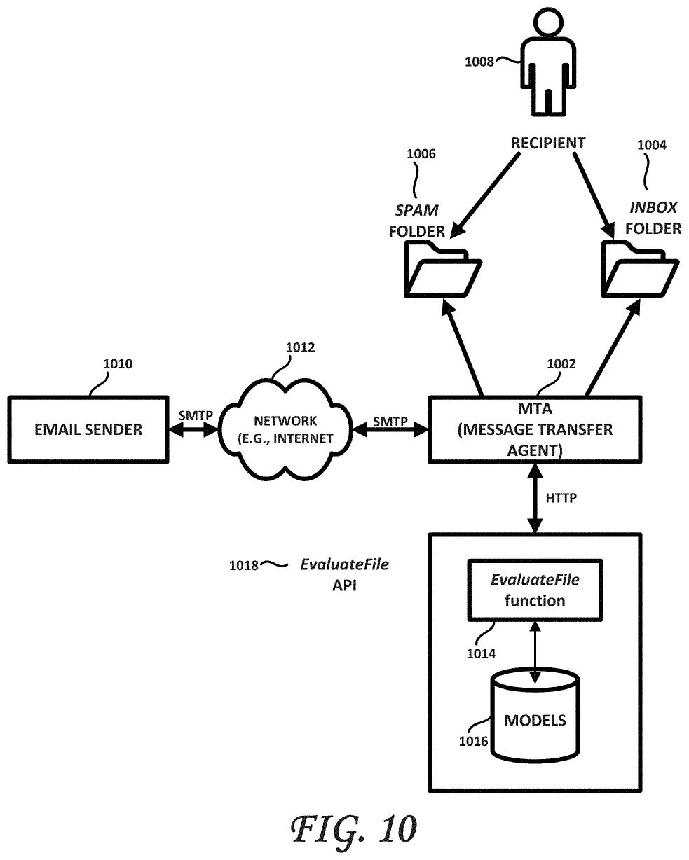

FIGS. 9 and 10 present the use case of an email received by a MTA (Message Transfer Agent) 1002 via SMTP (Simple Mail Transfer Protocol). The EvaluateFile function is used by the MTA 1002 to decide whether the email is likely to be benign and thus should be delivered to the Inbox 1004 of end user 1008, or whether the email is likely to contain malicious code in one of his attachments and thus should be moved to the Spam folder 1006, deleted or subjected to some other defensive treatment.

As shown in FIGS. 9 and 10, an email or other electronic message may be sent by an email sender 1010 through a computer network 1012 (including, for example, the Internet and/or other private or public networks). The MTA 1002 may then communicate via HTTP (Hyper Text Transfer Protocol), with an API (Application Program Interface) service 1018 configured to carry out the present embodiments. Alternatively, some or all of the functionality described herein and shown in FIGS. 8 and 9 in particular, may be carried out within the MTA 1002. The flowchart of FIG. 9 shows a computer-implemented method according to one embodiment. As shown therein, Block B902 calls for attachments {f₁, . . . , fₙ} to be extracted from the email or other electronic message. If there is at least one attachment, then the diagram proceeds to block B904. Otherwise, the email may be delivered to the Inbox 1004 of the recipient, as shown at B908. As shown at B904, each attachment may then be evaluated with the EvaluateFile function 1014 against models 1016. If there is at least one attachment fᵢ where EvaluateFile(fᵢ) returns CodeObfuscated, then the email may be moved to the Spam folder 1006 as shown at B906, deleted or some other precautionary action may be taken, as the email attachment contains obfuscated code. As such, it is very likely that at least one attachment of the email contains malicious code. Otherwise, the email may be delivered to the inbox of the recipient, as shown at B908.

Note that FIGS. 9 and 10 represent a simplified MTA workflow, respectively from a behavioral and structural point of view. Typical MTA workflows may be more complex, as additional processes may be applied, and accordingly additional software and/or hardware components may be involved. For example, these representative additional processes may be applied upon reception of an email:
More or less complex workflow rules may be applied,
One or several IP address blacklists may be applied,
One or several anti-spam filters may be applied,
One or several anti-virus filters may be applied,
Etc.

Furthermore, in the case where at least one email attachment of the email contains potentially malicious code, alternative defensive policies may be applied including, for example, deleting the email, removing each potentially malicious attachment from the email and delivering the sanitized email to the end user's inbox, performing a behavioral analysis of each potentially malicious attachment with a sandboxing technology, and delegating the delivery decision (to deliver or not to deliver the email and/or its attachment) to the sandboxing technology, to name but a few of the possibilities. Another defensive action that may be taken if the extracted attachment is determined to contain obfuscated code may include disabling a functionality of the obfuscated code before delivery to the end user. Note that, in one embodiment, the EvaluateFile function may be provided as a HTTP-based API, as shown in FIG. 10, although other implementations are possible, as those of skill in this art may recognize.

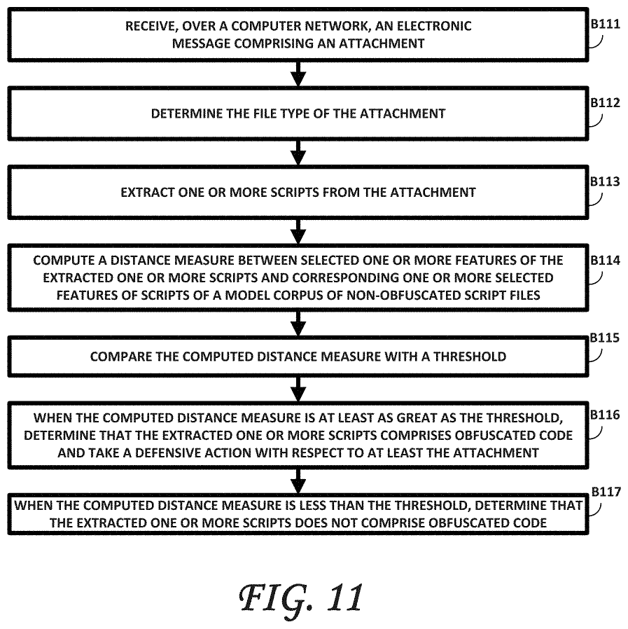

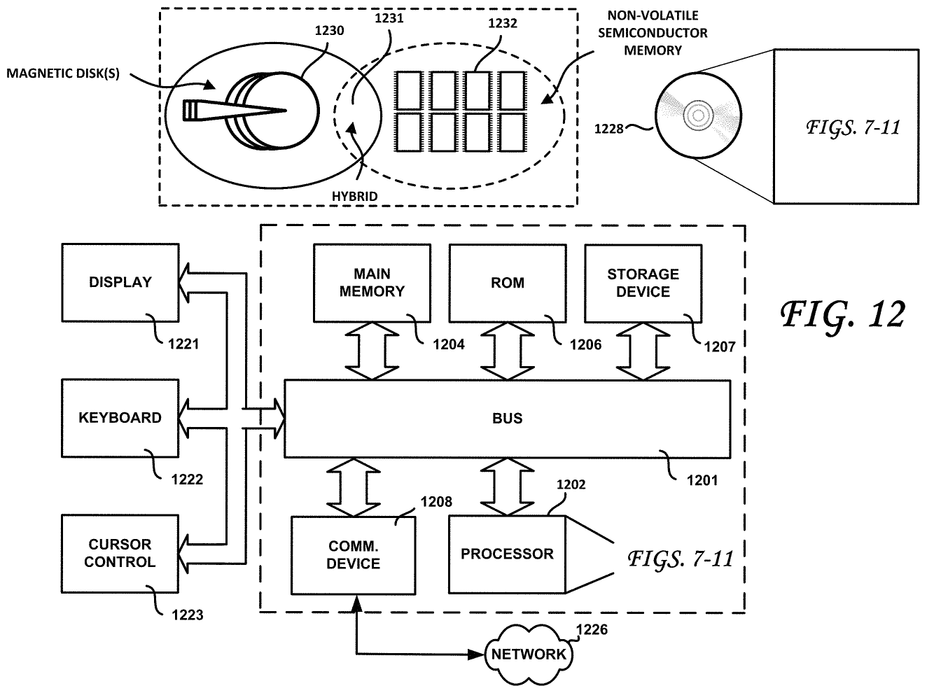

FIG. 11 is a flowchart of a computer-implemented method for detecting obfuscated code, according to one embodiment. As shown therein, block B111 calls for receiving, over a computer network, an electronic message comprising an attachment. At B112, the file type of the attachment may be determined and at B113, one or more scripts may be extracted therefrom. Then, a distance measure between selected one or more features of the extracted script(s) (e.g., variable names, function names, comments, alphanumeric characters, special characters, to name but a few representative features) and corresponding one or more selected features of scripts of a model corpus of non-obfuscated script files may be computed, as shown at B114. The computed distance measure may then be compared with a threshold (which may be predetermined or dynamically-determined), as shown at B115. When, as shown at B116, the computed distance measure is at least as great as the threshold, it may be determined that the extracted script(s) comprise obfuscated code and one or more defensive actions may be taken with respect to the attachment (and optionally the email itself), as shown at B116. Lastly, when the computed distance measure is less than the threshold, it may be determined that the extracted script(s) does not comprise obfuscated code, as suggested at B117.

In other embodiments, the computer-implemented method may further comprise applying a whitelist of known, non-obfuscated scripts against the extracted script(s) and the distance may be computed only on those extracted scripts (if any) having no counterpart in the whitelist. The method may also comprise determining the scripting language of the extracted script(s). The computer-implemented method may further comprise computing a probability distribution of the one or more features (variable names, function names, comments, alphanumeric characters and/or special characters, for example) of the extracted script(s). In that case, the computed distance measure may comprise a computed distance between the computed probability distribution of the one or more features of the extracted script(s) and a previously-computed probability distribution of the corresponding one or more selected features of scripts of a model corpus of non-obfuscated script files. For example, the computed distance may be a Jensen-Shannon distance or a Wasserstein distance.

In one embodiment, the defensive action may include delivering the received electronic message to a predetermined folder (such as a spam folder, for example) deleting the electronic message and/or its attachment and/or delivering a sanitized version of the attachment, without the obfuscated code, to an end user. When the extracted script(s) is determined to not comprise obfuscated code, the method may further comprise forwarding the electronic message and the attachment to an end user. The computer-implemented method, in one embodiment, may be at least partially performed by a MTA.

FIG. 12 illustrates a block diagram of a computing device such as may be used by an MTA, with which embodiments may be implemented. The computing device of FIG. 12 may include a bus 1201 or other communication mechanism for communicating information, and one or more processors 1202 coupled with bus 1201 for processing information. The computing device may further comprise a random-access memory (RAM) or other dynamic storage device 1204 (referred to as main memory), coupled to bus 1201 for storing information and instructions to be executed by processor(s) 1202. Main memory (tangible and non-transitory, which terms, herein, exclude signals per se and waveforms) 1204 also may be used for storing temporary variables or other intermediate information during execution of instructions by processor 1202. The computing device of FIG. 12 may also include a read only memory (ROM) and/or other static storage device 1206 coupled to bus 1201 for storing static information and instructions for processor(s) 1202. A data storage device 1207, such as a magnetic disk and/or solid-state data storage device may be coupled to bus 1201 for storing information and instructions—such as would be required to carry out some or all of the functionality shown and disclosed relative to FIGS. 7-11. The computing device may also be coupled via the bus 1201 to a display device 1221 for displaying information to a computer user. An alphanumeric input device 1222, including alphanumeric and other keys, may be coupled to bus 1201 for communicating information and command selections to processor(s) 1202. Another type of user input device is cursor control 1223, such as a mouse, a trackball, or cursor direction keys for communicating direction information and command selections to processor(s) 1202 and for controlling cursor movement on display 1221. The computing device of FIG. 12 may be coupled, via a communication interface (e.g., modem, network interface card or NIC) 1208 to the network 1226.

As shown, the storage device 1207 may include direct access data storage devices such as magnetic disks 1230, non-volatile semiconductor memories (EEPROM, Flash, etc.) 1232, a hybrid data storage device comprising both magnetic disks and non-volatile semiconductor memories, as suggested at 1231. References 1204, 1206 and 1207 are examples of tangible, non-transitory computer-readable media having data stored thereon representing sequences of instructions which, when executed by one or more computing devices, implement the computer-implemented methods described and shown herein. Some of these instructions may be stored locally in a client computing device, while others of these instructions may be stored (and/or executed) remotely and communicated to the client computing over the network 1226. In other embodiments, all of these instructions may be stored locally in the client or other standalone computing device, while in still other embodiments, all of these instructions are stored and executed remotely (e.g., in one or more remote servers) and the results communicated to the client computing device. In yet another embodiment, the instructions (processing logic) may be stored on another form of a tangible, non-transitory computer readable medium, such as shown at 1228. For example, reference 1228 may be implemented as an optical (or some other storage technology) disk, which may constitute a suitable data carrier to load the instructions stored thereon onto one or more computing devices, thereby re-configuring the computing device(s) to one or more of the embodiments described and shown herein. In other implementations, reference 1228 may be embodied as an encrypted solid-state drive. Other implementations are possible.

Embodiments of the present invention are related to the use of computing devices to implement novel detection of obfuscated code. Embodiments provide specific improvements to the functioning of computer systems by defeating mechanisms implemented by cybercriminals to obfuscate code and evade detection of their malicious code. Using such improved computer system, URL scanning technologies such as disclosed in commonly-assigned U.S. patent application Ser. No. 16/368,537 filed on Mar. 28, 2019, the disclosure of which is incorporated herein in its entirety, may remain effective to protect end-users by detecting and blocking cyberthreats employing obfuscated code. According to one embodiment, the methods, devices and systems described herein may be provided by one or more computing devices in response to processor(s) 1202 executing sequences of instructions, embodying aspects of the computer-implemented methods shown and described herein, contained in memory 1204. Such instructions may be read into memory 1204 from another computer-readable medium, such as data storage device 1207 or another (optical, magnetic, etc.) data carrier, such as shown at 1228. Execution of the sequences of instructions contained in memory 1204 causes processor(s) 1202 to perform the steps and have the functionality described herein. In alternative embodiments, hard-wired circuitry may be used in place of or in combination with software instructions to implement the described embodiments. Thus, embodiments are not limited to any specific combination of hardware circuitry and software. Indeed, it should be understood by those skilled in the art that any suitable computer system may implement the functionality described herein. The computing devices may include one or a plurality of microprocessors working to perform the desired functions. In one embodiment, the instructions executed by the microprocessor or microprocessors are operable to cause the microprocessor(s) to perform the steps described herein. The instructions may be stored in any computer-readable medium. In one embodiment, they may be stored on a non-volatile semiconductor memory external to the microprocessor or integrated with the microprocessor. In another embodiment, the instructions may be stored on a disk and read into a volatile semiconductor memory before execution by the microprocessor.

Portions of the detailed description above describe processes and symbolic representations of operations by computing devices that may include computer components, including a local processing unit, memory storage devices for the local processing unit, display devices, and input devices. Furthermore, such processes and operations may utilize computer components in a heterogeneous distributed computing environment including, for example, remote file servers, computer servers, and memory storage devices. These distributed computing components may be accessible to the local processing unit by a communication network.

The processes and operations performed by the computer include the manipulation of data bits by a local processing unit and/or remote server and the maintenance of these bits within data structures resident in one or more of the local or remote memory storage devices. These data structures impose a physical organization upon the collection of data bits stored within a memory storage device and represent electromagnetic spectrum elements.

A process, such as the computer-implemented detection of obfuscated code in application software files methods described and shown herein, may generally be defined as being a sequence of computer-executed steps leading to a desired result. These steps generally require physical manipulations of physical quantities. Usually, though not necessarily, these quantities may take the form of electrical, magnetic, or optical signals capable of being stored, transferred, combined, compared, or otherwise manipulated. It is conventional for those skilled in the art to refer to these signals as bits or bytes (when they have binary logic levels), pixel values, works, values, elements, symbols, characters, terms, numbers, points, records, objects, images, files, directories, subdirectories, or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, positioning, placing, illuminating, removing, altering and the like. The operations described herein are machine operations performed in conjunction with various input provided by a human or artificial intelligence agent operator or user that interacts with the computer. The machines used for performing the operations described herein include local or remote general-purpose digital computers or other similar computing devices.

In addition, it should be understood that the programs, processes, methods, etc. described herein are not related or limited to any particular computer or apparatus nor are they related or limited to any particular communication network architecture. Rather, various types of general-purpose hardware machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

While certain example embodiments have been described, these embodiments have been presented by way of example only and are not intended to limit the scope of the embodiments disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the embodiments disclosed herein.

1. A computer-implemented method for detecting obfuscated code in electronic messages, the computer-implemented method comprising:
receiving, over a computer network, an electronic message comprising an attachment;
determining a file type of the attachment;
extracting one or more scripts from the attachment;
computing a distance measure between selected one or more features of the extracted one or more scripts and corresponding one or more selected features of scripts of a model corpus of non-obfuscated script files;
comparing the computed distance measure with a threshold;
when the computed distance measure is at least as great as the threshold, determining that the extracted one or more scripts comprises obfuscated code and taking a defensive action with respect to at least the attachment; and
when the computed distance measure is less than the threshold, determining that the extracted one or more scripts does not comprise obfuscated code.

2. The computer-implemented method of claim 1, further comprising applying a whitelist of known, non-obfuscated scripts against the extracted one or more scripts and computing the distance measure only on those extracted scripts, if any, having no counterpart in the whitelist.

3. The computer-implemented method of claim 1, further comprising determining a scripting language of the extracted one or more scripts.

4. The computer-implemented method of claim 1, further comprising computing a probability distribution of the one or more features of the extracted one or more scripts and wherein the computed distance measure comprises a computed distance between the computed probability distribution of the one or more features of the extracted one or more scripts and a previously-computed probability distribution of the corresponding one or more selected features of the scripts of a model corpus of non-obfuscated script files.

5. The computer-implemented method of claim 1, wherein the computed distance is one of a Jensen-Shannon distance and a Wasserstein distance.

6. The computer-implemented method of claim 1, wherein the one or more features comprise at least one of variable names, function names and comments in the extracted one or more scripts.

7. The computer-implemented method of claim 1, wherein the one or more features comprise alphanumeric characters in the extracted one or more scripts.

8. The computer-implemented method of claim 1, wherein the one or more features comprise special characters in the extracted one or more scripts.

9. The computer-implemented method of claim 1, wherein the defensive action includes at least one of delivering the received electronic message to a predetermined folder, deleting the electronic message and/or its attachment, applying additional analysis to the received electronic message and delivering a sanitized version of the attachment, without the obfuscated code, to an end user.

10. The computer-implemented method of claim 1, performed at least in part by a Message Transfer Agent (MTA).

11. The computer-implemented method of claim 1, wherein when the extracted one or more scripts is determined to not comprise obfuscated code, the method further comprises forwarding the electronic message and the attachment to an end user.

12. A computing device comprising:
at least one processor;
at least one data storage device coupled to the at least one processor;
a network interface coupled to the at least one processor and to a computer network;
a plurality of processes spawned by the at least one processor to detect obfuscated code in an electronic message, the processes including processing logic for:
receiving, over a computer network, an electronic message comprising an attachment;
determining a file type of the attachment;
extracting one or more scripts from the attachment;
computing a distance measure between selected one or more features of the extracted one or more scripts and corresponding one or more selected features of scripts of a model corpus of non-obfuscated script files;
comparing the computed distance measure with a threshold;
when the computed distance measure is at least as great as the threshold, determining that the extracted one or more scripts comprises obfuscated code and taking a defensive action with respect to at least the attachment; and
when the computed distance measure is less than the threshold, determining that the extracted one or more scripts does not comprise obfuscated code.

13. The computing device of claim 12, further comprising processing logic for applying a whitelist of known, non-obfuscated scripts against the extracted one or more scripts and computing the distance measure only on those extracted scripts, if any, having no counterpart in the whitelist.

14. The computing device of claim 12, further comprising processing logic for determining a scripting language of the extracted one or more scripts.

15. The computing device of claim 12, further comprising processing logic for computing a probability distribution of the one or more features of the extracted one or more scripts and wherein the computed distance measure comprises a computed distance between the computed probability distribution of the one or more features of the extracted one or more scripts and a previously-computed probability distribution of the corresponding one or more selected features of scripts of a model corpus of non-obfuscated script files.

16. The computing device of claim 12, wherein the computed distance is one of a Jensen-Shannon distance and a Wasserstein distance.

17. The computing device of claim 12, wherein the one or more features comprise at least one of variable names, function names and comments in the extracted one or more scripts.

18. The computing device of claim 12, wherein the one or more features comprise alphanumeric characters in the extracted one or more scripts.

19. The computing device of claim 12, wherein the one or more features comprise special characters in the extracted one or more scripts.

20. The computing device of claim 12, wherein the defensive action includes at least one of delivering the received electronic message to a predetermined folder, deleting the electronic message and/or its attachment and delivering a sanitized version of the attachment, without the obfuscated code, to an end user.

21. The computing device of claim 12, configured as a Message Transfer Agent (MTA).

22. The computing device of claim 12, further comprising processing logic for forwarding the electronic message and its attachment to a an end user when the extracted one or more scripts is determined to not comprise obfuscated code.

23. A computer-implemented method of detecting obfuscated code in electronic messages, the computer-implemented method comprising:
receiving, over a computer network, an electronic message comprising an attachment;
determining a file type of the attachment;
extracting one or more scripts from the attachment;
applying a whitelist of known, non-obfuscated scripts against the extracted one or more scripts;
determine a scripting language of any remaining extracted scripts having no counterpart in the whitelist;
computing a probability distribution of character unigrams of one or more selected features of the remaining extracted script or scripts;
computing a distance between the computed probability distribution of character unigrams of one or more selected features of the remaining script or scripts and a probability distribution of character unigrams of one or more corresponding features of scripts of a model corpus of non-obfuscated script files;
comparing the computed distance with a threshold;
when the computed distance is at least as great as the threshold, determining that the remaining script or scripts comprises obfuscated code, taking a defensive action with respect to at least the attachment; and
when the computed distance is less than the threshold, determining that the remaining script or scripts does not comprise obfuscated code.

24. The computer-implemented method of claim 23, wherein the computed distance is one of a Jensen-Shannon distance and a Wasserstein distance.

25. The computer-implemented method of claim 23, wherein the character unigrams comprise characters of at least one of variable names, function names and comments in the extracted one or more scripts.

26. The computer-implemented method of claim 23, wherein the character unigrams comprise alphanumeric characters in the extracted one or more scripts.

27. The computer-implemented method of claim 23, wherein the character unigrams comprise special characters in the extracted one or more scripts.
